(19) United States
(12) Patent Application Publication
(10) Pub. No.: US 2008/0027799 A1
(43) Pub. Date: Jan. 31, 2008

(54) Location-based advertising

(75) Inventors: Jianxiu Hao, Lexington, MA (US); Zhiying Jin, Lexington, MA (US); Dahai Ren, Waltham, MA (US); Lazar Koyfman, Framingham, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignees: Verizon Directory Services - West Inc., DFW Airport, TX (US); Verizon Data Services Inc., Temple Terrace, FL (US)

(21) Appl. No.: 11/495,274

(22) Filed: Jul. 28, 2006

(51) Int. Cl. G06Q 30/00

(52) U.S. Cl. 705/14

(57) ABSTRACT

A first request for information that is related to a specified location is received. A first query for advertisements related to the specified location is submitted. A response to the first query that includes one or more advertisements related to the specified location is received. At least one of the one or more advertisements related to the specified location is sent to a client device. A second query for the information based on the first request is submitted. A first search result that is responsive to the second query is received. Information that is related to the location based on the first search result is sent to the client device after sending at least one of the one or more advertisements to the client device.

### BACKGROUND INFORMATION

Use of mobile devices such as cellular telephones, personal digital assistants, handled computers, etc., is becoming increasingly common. Such mobile devices are known to include a variety of software applications, including, for example, games, calendars, address books, and the like. Further, many mobile devices include a web browser or the like for accessing the Internet or some similar network providing various kinds of information content. Using a browser or some other application, it is generally possible for a user to access a wide variety of content, including information from directories such as telephone yellow pages directories, white pages directories, restaurant guides, travel guides, and the like, to thereby obtain search results responsive to a user's request. Such information and search results may be particularly useful to a user who has traveled to a particular location, and who seeks information related to that location. For example, a user in New York City may, while standing on a street corner, wish to obtain information related to nearby stores, restaurants, bus stops, etc. Indeed even a user at a computer in a coffee shop, hotel, or even a home or office, may wish to obtain information about nearby establishments, geographical items of interest, landmarks, etc.

It is possible to display advertisements to users of computing devices, including mobile devices. Indeed, an information content provider may wish to provide information to users such as mobile device users free of charge, and profit by displaying advertisements to such users. However, users of mobile devices, and indeed, the Internet in general, may be located anywhere in the world. Many advertisers, particularly local advertisers, cannot presently justify purchasing advertisements that may be presented to an audience far beyond the advertiser's local area. This is especially true considering that such advertisements may priced to reflect their potential global reach, and have no guarantee, and indeed, probably little chance, of being viewed by users proximate to the local advertiser. Unfortunately, information providers do not presently have a way to provide advertisements to users of mobile devices based on the location of a mobile device at the time a request for information is received.

### BRIEF DESCRIPTION OF THE DRAWINGS

FIG. 1 illustrates a system for providing a mobile device with information, including advertisements, according to an embodiment.

FIG. 2A illustrates a graphical user interface that may be displayed in a client device by a client application upon accessing a server application, according to an embodiment.

FIG. 2B, illustrates a graphical user interface including a choose location menu to allow a user to select an option for specifying a location for a search, according to an embodiment.

FIG. 2C illustrates a graphical user interface including a list of options for identifying a city, according to an embodiment.

FIG. 2D illustrates a graphical user interface including a form for providing input identifying a city, according to an embodiment.

FIG. 2E illustrates a graphical user interface including a form for providing input identifying a state, according to an embodiment.

FIG. 2F illustrates a graphical user interface including a form for a selection of a location by a city and a state, according to an embodiment.

FIG. 3 illustrates a process for displaying advertisements, according to an embodiment.

FIG. 4 illustrates a process for selecting advertisements for display in client, according to an embodiment.

### DETAILED DESCRIPTION OF THE PREFERRED EMBODIMENTS

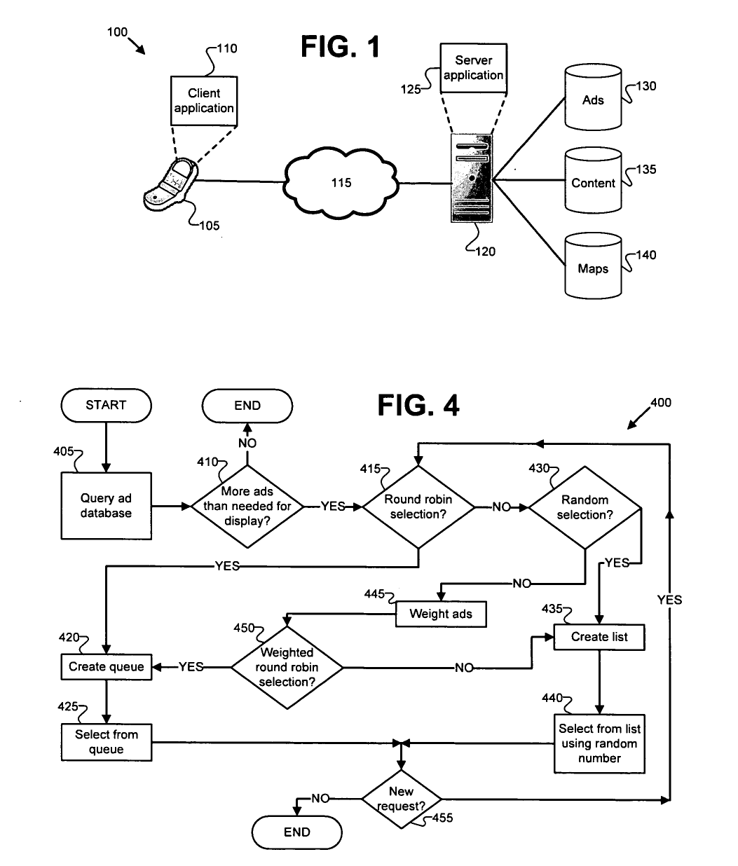

FIG. 1 illustrates a system 100 for providing a client device 105 with requested information and advertisements, according to an embodiment. Client device 105 generally includes client application 110, and communicates via network 115 with server 120. Server 120 in turn generally includes server application 125, and communicates with advertisement database 130, content database 135, and/or map database 140.

Client device 105 may be any one of a number of known mobile or portable computing devices, such as a cellular telephone, personal digital assistant, handheld computer, etc. Client device 105 includes a software operating system and/or firmware sufficient to allow for the operation of client application 110. Client application 110 may be developed according to a number of known technologies and or operating systems that may be installed on client device 105, such as Java™ Platform, Micro Edition, also known as J2ME, distributed by Sun Microsystems of Santa Clara, Calif.; Openwave® WAP Push Library for Wireless Application Protocol (WAP), distributed by Openwave Systems Inc., of Redwood City, Calif.; Binary Runtime Environment for Wireless (BREW®), distributed by Qualcomm, Inc., of San Diego, Calif.; the Microsoft® .Net Compact Framework, distributed by Microsoft Corporation of Redmond, Wash.; Palm OS®, distributed by Palm, Inc., of Sunnyvale, Calif.; Windows® Mobile, distributed by Microsoft Corporation of Redmond, Wash.; Symbian OS distributed by Symbian, Ltd., of London, United Kingdom, etc.

Further, embodiments are contemplated in which client device 105 is a stationary computing device, or at least a device that, while portable, is used in a stationary state, such as a personal computer, handheld computer, laptop computer, desktop computer, etc. Accordingly, programming technologies compatible with the Windows operating system distributed by Microsoft Corporation of Redmond, Wash., the well known open source Linux operating system, etc., may be used for client application 110.

Generally, client device 105, in addition to a display that usually but not necessarily incorporates a graphical user interface (GUI), includes one or more known input devices, such as a pointing device, keyboard or keypad, touch screen, etc. Accordingly, client application 110 provides functionality such as is known in a web browser for allowing a user to navigate to a particular web page and/or web site and view information content. Further, client application 110, in combination with one or more input devices in client device 105, allows a user to submit requests for information, including requests for information relating to a specified location, to server 120 via network 115. Client application 110 generally receives and displays the results of such searches, possibly including textual information, photographic images, maps such as stored in map database 140, and possibly even other media, such as video and audio.

Network 115 is one or more networks known for transporting data between telecommunications and/or computing devices, such as a cellular telephone network, a local area network (LAN), a wide area network (WAN) such as the Internet, etc.

Server 120 is generally a combination of hardware and software, the software including an operating system such as the foregoing Windows or Linux operating systems, or a variation of the Unix operating system, such as Solaris, distributed by Sun Microsystems of Santa Clara, Calif., or AIX, distributed by International Business Machines of Armonk, N.Y. Accordingly, server application 125 may be written according to a number of different known programming technologies, or a combination thereof, such as the Java programming language, the C sharp programming language, C/C++, .NET, etc.

Server application 125 generally receives requests from client device 105, including requests for information concerning a specified geographic location. Further, server application 125 obtains requested information and returns a response to client device 105. Server 120 may be in communication with advertisement database 130, content database 135, and/or map database 140 to obtain requested information. The information stored in and retrieved from databases 130, 135 and 140 is described in more detail below. In addition, it should be understood that, in most embodiments, system 100 may include other databases and/or servers not shown in FIG. 1 for providing information and functionality to client device 105.

Computing devices in various embodiments such as client device 105 and server 120 may each include computer-executable instructions. Such instructions may be compiled or interpreted from computer programs created using a variety of known programming languages and/or technologies, including, without limitation, and either alone or in combination, Java™, C, C++, Visual Basic, Java Script, Perl, etc., as mentioned above. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Databases 130, 135, and 140 generally comprise a structured file (e.g., comma delimited, tab delimited, etc.) or a relational database management system (RDBMS) as is well known. Further, databases 130, 135, and 140 may be capable of storing and providing data in addition to alphanumeric data, such as image data, binary data, etc. Generally, an RDBMS generally employs the well known Structured Query Language (SQL) in addition to a language for creating, storing, editing, and executing stored procedures. However, it is to be understood that databases 130, 135, and 140 may be some other kind of database such as a hierarchical database, a file, a set of files, an application database in a proprietary format, etc. Databases 130, 135, and 140 generally include a computing device employing a computer operating system such as one of those mentioned above, and is accessible via a networking technology as is well known, such as a local area network (LAN), wide area network (WAN), etc. Embodiments are possible in which one or more of databases 130, 135, and 140 are included in server 120.

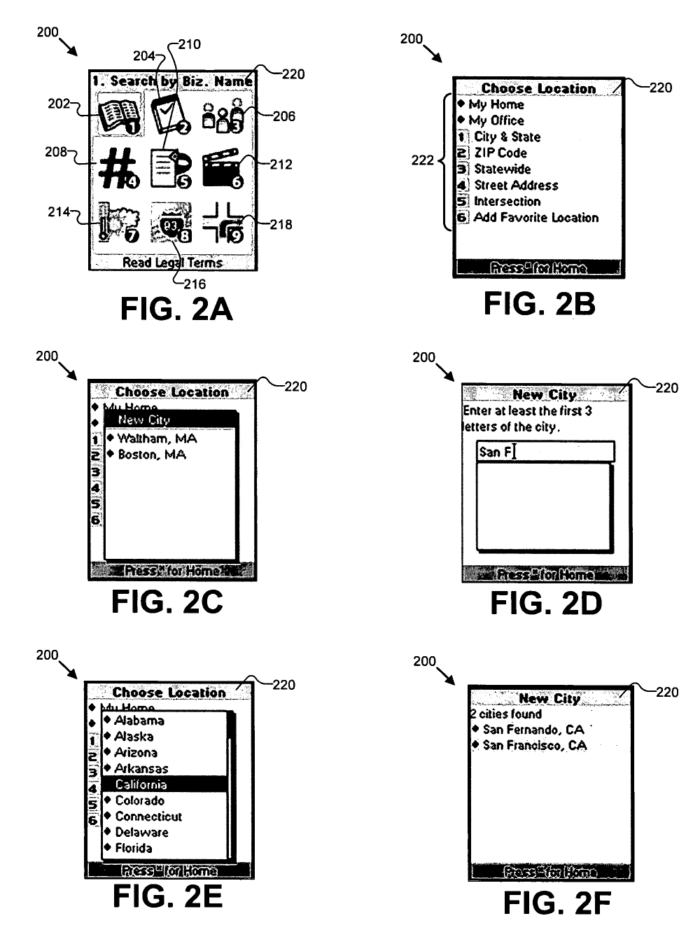

FIG. 2A shows a GUI 200 that may be displayed in client device 105 by client application 110 upon accessing server application 125, according to an embodiment. As seen in FIG. 2A, client device 105 displays icons 202, 204, 206, 208, 210, 212, 214, 216, 218, and 220 for indicating options available to a user to search for information. Thus, in one embodiment, a user of client device 105 may indicate icon 202 to search for a business by name, icon 204 to search for a business by type, icon 206 to perform a search for a person, icon 208 to perform a search according to a telephone number, icon 210 to access previously stored searches, icon 212 to search movie listings, icon 214 to obtain weather forecasts, icon 216 to obtains maps of a specified location, and icon 218 to obtain driving directions. Text area 220 provides a brief textual explanation relating to an icon 202, 204, 206, 208, 210, 212, 214, 216, 218, or 220 selected, e.g., by hovering, by a user with a cursor or pointing device provided in client device 105.

Further examples of GUI 200 are illustrated in FIGS. 2B-2F, which figures are discussed further below.

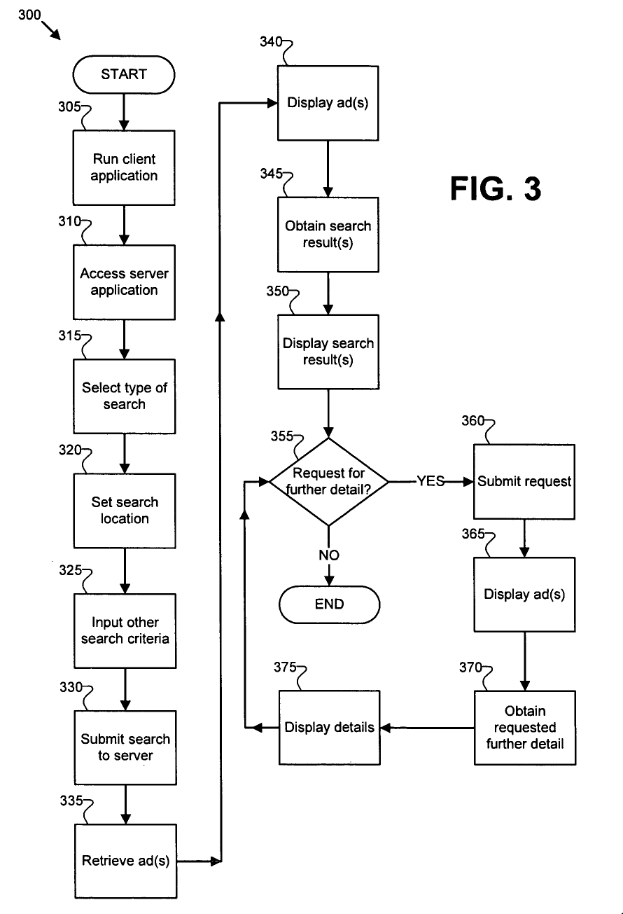

FIG. 3 illustrates a process 300 for displaying advertisements, according to an embodiment.

In step 305, client application 110 is initiated on client device 105, e.g., by a user of client device 105 selecting an option to run client application 110.

Next, in step 310, client application 110 accesses server application 125. In various embodiments, client application 110 could be a web browser installed on client device 105 that is capable of accessing a variety of web pages and available content, or client application could be a custom application installed on client device 105 that is designed specifically to interact with server application 125. In this latter case, client application 110 may be programmed to access server application 125 automatically when client application 110 is initiated. However, in embodiments in which client application 110 is a web browser or the like that is programmed for accessing a variety of content from client device 105, a user action, such as selecting a web page to browse to, may be necessary in step 210. In any event, the result of step 310 is that client device 105 displays an interface for a location-based search. As noted above, in preferred embodiments, client device 105 includes a GUI for displaying information to users and allowing users to provide input. For example, GUI 200 such as shown in FIG. 2A may be displayed in step 310.

Next, in step 315, a user of client application 110 selects a type of search to be performed, For example, with reference to FIG. 2A, a user may select one of icons 202, 204, 206, 208, 210, 212, 214, 216, or 218 in GUI 200.

Next, in step 320, a location for a search is specified. The location specified in step 320 may take a number of different forms, including but not limited to the name of a city, a zip or other postal code, a street address, known landmarks, features of geography, a geo-coordinate, etc.

Further, such location may be specified in a variety of different ways, such as an auto-tracking mechanism. For example, it is known to use elements within a cellular telephone network that may be included within network 115 to detect a location of client device 105. Where a cellular phone is only able to communicate with a single network interface (e.g., a cellular tower) then the position of the cellular phone must be within the normal range of the single network interface. Where a cellular phone is able to communicate with more than one network interface (e.g., more than one cellular tower) then a triangulation technique may be used to more accurately determine the location. Moreover, location services are routinely performed when a cell phone is turned on and for “Emergency 911” services. Use of global positioning system (GPS) technology is similarly known. Some embodiments may include an embedded GPS system, for example, in a phone, PDA, computer, or other device. Accordingly, in some embodiments, server application 125 is programmed to automatically obtain a location for a search in step 320, e.g., by obtaining such information from network 115.

In other embodiments, a user of client application 110 provides input to specify a location for a search. For example, as shown in FIG. 2B, GUI 200 may display choose location menu 222 to allow a user to select an option for specifying a location for a search. Upon selecting a “City & State” option as shown in FIG. 2B, a user could be presented with a list of options for identifying a city, as shown in FIG. 2C, and the user could be asked to provide input identifying a city as shown in FIG. 2D, and a state, as shown in FIG. 2E. Further, FIG. 2F shows a display in GUI 200 by which a user can confirm a selection of a location by a city and a state.

Continuing with the description of process 300, next, in step 325, a user of client application 110 inputs a criterion or criteria for a search other than the location specified in step 320. Although examples are not illustrated in the figures, it is to be understood that such input may be provided through GUI 200 in a manner consistent with FIGS. 2A-2F. Such additional criteria may variously include the name of a person or business, a type of business, e.g., “Chinese restaurants,” a telephone number, a movie name, a request for a weather forecast, a request for a map, etc.

It should be understood that the additional criteria specified in step 325 should be consistent with the type of search specified in step 315. For example, if the type of search specified in step 315 was a search by business type, then a type of business, e.g., “Chinese restaurant,” “book store,” etc. should be specified in step 325. Accordingly, for at least some types of search, GUI 200 may include forms for enforcing the search criteria provided by a user, e.g., by presenting a list of business types from which the user must select.

Next, in step 330, search criteria selected in steps 315-325 are submitted to and received by server application 125, generally over network 115. It should be understood that such search criteria may alternatively be submitted after they are received in each of steps 315-325, and further that client device 105 may receive information from server 120 for populating forms in GUI 200 in each of steps 315-325 to allow a user of client application 110 to select search criteria. For example, where a selected search type in step 315 is a search for a type of business, upon receiving this selection server application 125 could supply client application 110 with a list of business types for a user to select in step 325. Further, upon a user selection of one of the supplied business types, server application 125 could provide to client application 110 a list of relevant subtypes for further selection, etc.

Next, in step 335, server application 125, having received the search request submitted in step 330, retrieves from advertisement database 130 one or more advertisements for display on client device 105 based on the search criteria submitted in step 330. Generally parameters in the search request submitted in step 330 are used to retrieve advertisements. It should be understood that, at a minimum, an advertisement is selected for display in step 335 because it is related or relevant to the location specified in step 320. Retrieval of advertisements from advertisement database 130 may be performed in a variety of known ways. In general, server application 125 formulates a query for advertisement database 130 that returns multiple advertisements from which server application 125 in turn selected one or more advertisements to be sent to and displayed on client device 105. However, it is also possible that no advertisements will be relevant for display on client 105 and responsive to such a query, in which case no advertisements will be returned to server application 125 in step 335. Further, heuristics according to which one or more advertisements are selected for display on client device 105 from a set of advertisements that has been retrieved from advertisement database 130 are discussed in more detail below with reference to FIG. 4.

Next, in step 340, server application 125 causes generally at least one but possibly more advertisements retrieved from advertisement database 130 in step 335 to be displayed in an interface such as GUI 200 of client device 105, generally by sending such advertisement or advertisements to client device 105, whereby client application 110 displays the advertisement or advertisement in GUI 200. The advertisement or advertisements are advantageously displayed to a user of client device 105 during a period of time in which the search submitted in step 330 is being processed by server 120. Typically, such processing may consume anywhere from four to ten seconds, that is, four to ten seconds may elapse between the time when a user submits a search request as in step 330 above and the time when search results may be displayed on client device 105 as in step 350 below. Accordingly, instead of simply displaying a blank screen, or a message such as “processing request” on client device 10S during this time, advertisements may be displayed, providing a user with potentially useful information, and providing a content provider such as the provider of server application 125 with an opportunity to obtain previously unavailable revenue.

In the case in which no advertisement is returned to server application 125 in step 335, then it should be plain that no advertisement can be displayed on client device 105 in step 340. Accordingly, in this case, server application 125 may be programmed to communicate to client application 110 that no relevant advertisements have been located. Upon receiving such a message, client application 10 in turn may be programmed to proceed in a variety of ways, including to continue displaying prior contents of GUI 200, to display a message such as “processing request,” etc.

In step 345, server application 125 on server 120 obtains requested information from content database 135, and/or map database 140. It is possible that server application 125 may submit requests for information to content database 135, and/or map database 140 in step 345, or immediately upon receiving a search request from client application 110 in step 330. In any event, in step 345, server application 125 receives requested information from databases 135 and/or 140 in step 345, and further formats such information as necessary for sending to client device 105 so that such information may be displayed by client application 110.

In step 350, client application 110 receives, from server application 125, and displays, in an interface included in client 105, the results of the search submitted in step 330. Generally the display of such search results replaces the advertisement displayed in step 340. However, it may be the case that a provider of server application and/or client application 110 wishes to ensure that advertisements will be displayed for a minimum amount of time, or that a user has had the opportunity to view the advertisement. Therefore, it is possible for a user of client device 105 to be presented with a message, e.g., in text area 220 of GUI 200, such as “Press ‘OK’ to view search results” or the like before the display of an advertisement is replaced with a display of search results. Alternatively, client application 110 may be programmed to ensure that an advertisement is displayed in GUI 200 for a minimum amount of time, e.g., five seconds, before search results are presented on client device 105. Generally, search results may be presented in GUI 200 using text, graphics, or some combination of text and graphics. For example, search results could include a list of businesses through which a user may scroll, a map of a geographic area, etc.

Next, in step 355, client application 110 determines whether a user of client device 105 has submitted a request for further detail concerning the search result or results displayed in step 350. For example, search results displayed in step 350 could include a list of all Chinese restaurants in a specified zip code, and in step 355 a user of client device 105 could request an address and telephone number for one of the listed restaurants. To take another example, search results displayed in step 350 could include a map displaying a certain geographic area, and a user of client device 105 could request to see a subset of the displayed areas. It should be clear that there are many other possible examples of a request for more detailed information that could be submitted in step 355 that are not enumerated herein.

In some embodiments, if a certain amount of time, e.g., two minutes, elapses without a user making a request for further information concerning search results displayed in step 350, client application 110 is programmed to presume that no such request has been or will be made, and process 300 ends. Further, during any part of process 300, server application will generally be programmed to assume that no further input from a user of client 105 will be submitted by client application 110 after a certain amount of time has elapsed, including in step 355.

Further, in some embodiments, client application 110 may be programmed to allow a user of client device 105 to provide input indicating that no further request for information concerning the search submitted in step 330 will be made. In any event, if client application 110 determines that a user of client device 105 has not submitted a request for further information concerning the search submitted in step 330, process 300 ends. Otherwise, process 300 proceeds to step 360.

In step 360, a user's request for additional detail concerning search results supplied in response to the request of step 330 is submitted to server application 125 on server 120, generally via network 115.

Next, in step 365, server application 125 selects one or more advertisements retrieved in step 335 for display on client 105, and, generally operating as in step 340, server application 125 causes one or more advertisements retrieved from advertisement database 130 in step 335 to be displayed in an interface such as GUI 200 of client device 200.

Next, in step 370, generally operating as in step 345, server application 125 on server 120 obtains further requested information concerning the search submitted in step 330 from content database 135, and/or map database 140.

Next, in step 375, generally operating as in step 350, client application 110 receives, from server application 125, and displays, in an interface included in client 105, the results of the search submitted in step 360.

Following step 375, process 300 returns to step 355 to determine if a user at client device 105 had requested any further information concerning the search submitted in step 330, and/or the search results supplied in step 360.

As noted above, the end of process 300 follows step 355.

FIG. 4 illustrates an exemplary process for selecting advertisements for display in client device 105. According to certain embodiments, process 400 describes in more detail processing the results of the query from server application 125 to advertisement database 130 discussed above with reference to step 335 of process 300. It is to be understood that ways of processing this query other than ways set forth with reference to FIG. 4 are also possible.

In step 405, server application 125 queries advertisement database 130 for advertisements relevant to a search request received from client application 110, e.g., as described above with reference to step 330 of process 300. Such a search request includes as parameters a location and also generally a category of information sought and/or one or more keywords describing the information sought. In one embodiment, advertisements in advertisement database 130 are grouped by location and also by categories and/or keywords. For example, an advertisement for a Chinese restaurant may be assigned to a “restaurant” category, an “ethnic” subcategory, and a further “Chinese” subcategory. Further, the advertisement for the Chinese restaurant may be associated with a street address, which is translated to a geo-coordinate that is stored in database 130 and associated with the advertisement. Further for example, an advertiser or advertisement may also be associated with a geographic region such as a zip code, a city, and/or a state, the geographic region being determined according to a geographic region that an advertiser is interested in. In addition, the advertisement could be associated with a variety of keywords, such as “Chinese restaurant,” “Asian dining,” “Hunan chicken,” etc.

Server application 125 queries advertisement database 130 according to parameters such as the foregoing to find relevant advertisements. In some embodiments an advertisement may satisfy only one value of a given parameter, while in other embodiments, such as embodiments using known fuzzy search techniques, an advertisement may satisfy multiple values of a given parameter. For example, an advertisement may be associated with a particular zip or postal code. However, if the zip or postal code is in turn associated with a particular city, specifying the zip code as a value for the location parameter may return both advertisements associated with the zip code as well as advertisements associated with the city. Further, it is generally desirable to retrieve advertisements associated with locations (or that are associated with advertisers that are in turn associated with locations) within a certain distance of a location requested in a search. For example, a search request could specify a street address, which street address is translated to a geo-coordinate pair by server application 125. Advertisements associated with geo-coordinates within a certain distance, e.g., five miles, of the street address may then be retrieved from advertisement database 130.

Next, in step 410, server application 125 receives results from the query sent in step 405, and determines whether the number of advertisements returned is greater than the number of advertisements that can be displayed on client device 105. In some embodiments, this number may be predetermined and included in programming instructions for server application 125. In other embodiments, this number may be dependent on client device 105 and/or network 115, e.g., because of the size of a display included within client device 105, the rate of data transmissions to client device 105, etc. Accordingly, in some embodiments, client application 110 may communicate a number of advertisements to be displayed to server application 125.

If the number of advertisements returned by the query sent in step 405 is greater than the number of advertisements that can be displayed on client device 105, process 400 proceeds to step 415. Otherwise, including the case in which no advertisements are returned by the query sent in step 405, process 400 ends.

Next, in step 415, it is determined whether a round robin selection heuristic will be used by server application 125 to select, from the set of advertisements received in step 410, one or more advertisements to be sent to client application 110. In some embodiments, server application 125 may be programmed to select a particular one of the selection heuristics described with reference to FIG. 4, such as a round robin selection heuristic. However, server application 125 could also be configurable by an administrator or user to determine a selection heuristic, or server 125 could be programmed to randomly or according to some rotation choose a selection heuristic. In any event, if it is determined in step 415 that a round robin selection heuristic is to be used to select advertisements, step 420 is next executed. Otherwise, step 430 is next executed.

In step 420, server application places advertisements received in step 410 into a queue in any order, e.g., the order in which the advertisements were listed when received from advertisement database 130. A queue is a well known data structure that provides stored data objects on a “first-in, first-out” basis.

Further, it is to be understood that, when reference is made to advertisements being placed into a queue or list, it is possible that the queue may include links or pointers to advertisements, and not the advertisements themselves. Particularly when reference is made below to placing multiple copies or instances of an advertisement in a queue or list, such reference in fact generally involves placing a link, pointer, or the like that references an advertisement in a queue or list, although of course embodiments are possible in which actual copies or multiple instances of an advertisement are created and placed in a queue or list. Also, advertisements could be placed in some other data object besides a queue or a list.

Next, in step 425, the advertisement at the top of the queue created in step 420 is selected form the queue and sent to client device 105 for display by client application 110. Further, if more than one advertisement may be displayed at a time on client device 105, or if, during the execution of process 300 described above, additional advertisements are requested for display, the next advertisement or advertisements in the queue may be provided to client application 110. Note that, once all advertisements in the queue have been used at least once, the advertisement that was originally at the top of the queue will be selected again, and so on, in round robin fashion.

In step 430, it is determined whether a random selection heuristic will be used by server application 125 to select, from the set of advertisements received in step 410, one or more advertisements to be sent to client application 110. If so, process 400 proceeds to step 435. However, if a random selection heuristic will not be used, step 445 is next executed.

In step 435 server application places advertisements received in step 410 into a list in any order, e.g., the order in which the advertisements were listed when received from advertisement database 130. A list is a well known data structure that holds a series of data elements, the data elements in a list usually being all of the same data type.

Next, in step 440, server application 125 generates a random integer in a range between and including one and the number of advertisements in the list. A number of advertisements equal to the random integer are counted, and the last advertisement counted in the list is sent to client application 110.

If step 445 is reached, it means that server application 125 is to assign a priority or weight to the advertisements received in step 410. Accordingly, in step 445, each of the advertisements received in step 410 is assigned an integer value representing a weight that is assigned to the advertisement. Various factors can be used to weight advertisements, according to various embodiments. For example, the amount that an advertiser has paid or is willing to pay for display of the advertisement on client device 105 is one factor that may be used to assign a weight to an advertisement. Similarly, a provider of server application 125 and/or client application 110 may wish to assign a weight to an advertisement based on the importance of an advertiser to the provider, i.e., advertisements associated with more important advertisers may be given greater weights than advertisements associated with less important advertisers.

Another factor that may be used in determining the weight assigned to an advertisement may be the distance of an advertiser's location from the geographic location of a user of client device 105, e.g., the location specified in step 320 of process 300. For example, in some embodiments geo-coordinates are associated with an advertisement or the location of an advertiser and also with the location of client device 105. Accordingly, it will be understood that it is possible to compute the distance between these two sets of geo-coordinates. Based on such computed distances, weights may be assigned to advertisements. For example, advertisements associated with more than a certain distance, e.g., ten miles, from client device 105 may be assigned a weight of zero, i.e., excluded from being placed in a data structure for display on client device 105. Further, advertisements associated with various ranges of distance from client device 105 may be assigned weights accordingly. For example, distances of five to ten miles may result in a weight of one; distances of three or four miles may result in a weight of two; distances of one or two miles may result in a weight of three; and distances of less than one mile may result in a weight of four.

In step 450, it is determined whether a weighted round robin selection heuristic will be used by server application 125 to select, from the set of advertisements received in step 410, one or more advertisements to be sent to client application 110. If so, process 400 proceeds to step 420. Otherwise, process 400 proceeds to step 435.

A weighted round robin selection heuristic is similar to the round robin selection heuristic described above with reference to steps 415-425, except that, instead of placing advertisements in a queue one time each, advertisements are placed in the queue one or more times according to their weight. For example, in an embodiment, each advertisement received in step 410 is placed into a queue a number of times equal to a weight of the advertisement assigned as described above with reference to step 445. That is, if an advertisement has a weight of four, it is placed into the queue four times, an advertisement with a weight of three would be placed into the queue three times, etc. Accordingly, when step 420 is visited following step 450, the queue created includes weighted advertisements, e.g., can include more than one instance of some or all of the advertisements received in step 410.

If a weighted round robin heuristic is not to be used, step 435 is next executed because a weighted, or modified, random selection heuristic is to be used. A weighted round robin selection heuristic is similar to the round robin selection heuristic described above with reference to steps 415-425, except that, instead of placing advertisements in a list one time each, advertisements are placed in the list one or more times according to their weight, much as described above with reference to the weighted round robin selection heuristic. Accordingly, when step 435 is visited following step 450, the list created includes weighted advertisements, e.g., can include more than one instance of some or all of the advertisements received in step 410.

Step 455 may be executed after either step 425 or step 440. In step 455, server application 125 determines whether a new request has been received for an advertisement received in step 410. Generally, after supplying one or more advertisements to client application 125, for example, as described above with reference to steps 340 and 365 of process 300, server application waits a predetermined period of time before removing such advertisements from storage in server 120, e.g., by releasing memory storing data objects, such as queues or lists as described above, that store the advertisements. If, during the predetermined period of time, a further request for one of the advertisements is received, e.g., for example, as described above with reference to steps 355-370 of process 300, then process 300 returns to step 415. Otherwise, e.g., if a predetermined period of time elapses without a request for another display of the one of the advertisements received in step 410, process 400 ends.

In conclusion, with regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Similarly, systems in certain embodiments could include elements not described herein, or could exclude certain elements that are described herein. In other words, the descriptions of processes, systems, methods, heuristics, etc. herein are provided for the purpose of illustrating certain embodiments, and should in no way be construed so as to limit the claimed invention.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the field of networks, and that the disclosed systems and methods will be incorporated into such future embodiments. In sum, it should be understood that the invention is capable of modification and variation and is limited only by the following claims.

What is claimed is:

1. A method, comprising:
receiving a first request for information that is related to a specified location;
submitting a first query for advertisements related to the specified location;
receiving a response to the first query that includes one or more advertisements related to the specified location;
sending at least one of the one or more advertisements related to the specified location to a client device;
submitting a second query for the information based on the first request;
receiving a first search result that is responsive to the second query; and
sending to the client device information that is related to the location based on the first search result after sending the at least one of the one or more advertisements to the client device.

2. The method of claim 1, further comprising:
displaying the at least one advertisement on the client device;
receiving the information at the client device; and
displaying the information on the client device after displaying the at least one advertisement, whereby the information replaces the advertisement on a display of the client device.

3. The method of claim 1, further comprising:
receiving a second request for information that is related to the specified location and that is related to the first search result;
sending at least one of the one or more advertisements related to the specified location to a client device, whereby the at least one of the one or more advertisements may be displayed on the client device;
submitting a third query for information requested in the second request;
receiving a second search result that is responsive to the third query; and
sending information to the client device related to the specified location based on the second search result.

4. The method of claim 1, wherein the at least one advertisement is a plurality of advertisements, the method further comprising using a selection heuristic to select at least one of the one or more advertisements related to the location to be sent to the client device.

5. The method of claim 4, wherein the selection heuristic includes at least one of a round robin selection heuristic, a random selection heuristic, a weighted round robin selection heuristic, and a modified random selection heuristic.

6. The method of claim 4, wherein distances between the specified location and locations respectively associated with the advertisements are used in the selection heuristic.

7. The method of claim 1, wherein the client device is a mobile device that wirelessly communicates with a network.

8. The method of claim 1, wherein the first request includes at least one of a category and a keyword.

9. The method of claim 1, wherein the specified location is provided by one of user input and an auto-tracking mechanism.

10. The method of claim 1, wherein the method is included in computer-executable instructions tangibly embodied on a computer-readable medium.

11. A system comprising a server that is configured to:
receive a first request for information that includes a specified location;
submit a first query to an advertisement database for advertisements relating to the location, wherein the advertisement database includes a plurality of advertisements, each of the advertisements relating to one or more of the locations;
receive one or more advertisements in response to the first query;
send at least one of the one or more advertisements over a network;
submit a second query to a content database for the information requested in the first request, wherein the a content database includes information relating to a plurality of locations;
receive a first search result from the content database that is responsive to the search for the information requested in the first request; and
send information related to the specified location over the network based on the first search result after sending the at least one of the one or more advertisements.

12. The system of claim 11, further comprising a client device that is configured to:
display the at least one advertisement on the client device while the second query is pending;
receiving the information related to the location; and
displaying the information related to the location.

13. The system of claim 11, wherein the server is further configured to:
receive a second request for information that is related to the specified location and that is related to the first search result;
send at least one of the one or more advertisements related to the specified location over the network;
submit a third query to the content database for information requested in the second request;
receive a second search result that is responsive to the search for information requested in the second request; and
send information related to the location and to the first search result that is based on the second search result over the network.

14. The system of claim 11, wherein the at least one advertisement is a plurality of advertisements, the method further comprising using a selection heuristic to select at least one of the one or more advertisements related to the location to be sent to the client device.

15. The system of claim 14, wherein the selection heuristic includes at least one of a round robin selection heuristic, a random selection heuristic, a weighted round robin selection heuristic, and a modified random selection heuristic.

16. The method of claim 14, wherein distances between the specified location and locations respectively associated with the advertisements are used in the selection heuristic.

17. The system of claim 12, wherein the client device is a mobile device that wirelessly communicates with a network.

18. The system of claim 11, wherein the first request includes at least one of a category and a keyword.

19. The system of claim 11, wherein the specified location is provided by one of user input and an auto-tracking mechanism.

20. A method, comprising:
receiving a first request for information that is related to a specified location;
submitting a first query for advertisements according to the first request;
receiving a response to the first query that includes one or more advertisements related to the specified location;
using a selection heuristic to select at least one of the advertisements related to the specified location to be sent to a client device;
sending at least one of the one or more advertisements related to the specified location to the client device;
submitting a second query for the information based on the first request;
receiving a first search result that is responsive to the second query;
sending to the client device information that is related to the location based on the first search result after sending the at least one of the one or more advertisements related to the specified location to the client device;
displaying the at least one advertisement on the client device while the second query is pending;
receiving at the client device the information that is related to the location based on the first search result; and
displaying on the client device the information that is related to the location based on the first search result.

21. The method of claim 20, further comprising:
receiving a second request for information that is related to the specified location and that is related to the first search result;
sending at least one of the one or more advertisements related to the specified location to a client device, whereby the at least one of the one or more advertisements may be displayed on the client device;
performing a search for information requested in the second request;
receiving a second search result that is responsive to the search for information requested in the second request;
sending information related to the location and to the first search result to the client device based on the second search result, whereby the information related to the location and to the first search result may be displayed on the client device; and
displaying the information related to the location and to the first search result on the client device.

22. The method of claim 20, wherein the selection heuristic includes at least one of a round robin selection heuristic, a random selection heuristic, a weighted round robin selection heuristic, a modified random selection heuristic, and a heuristic that uses distances between the specified location and locations respectively associated with the advertisements.
